(19) United States
(12) Patent Application Publication
(10) Pub. No.: US 2015/0249887 A1
(43) Pub. Date: Sep. 3, 2015

(54) SPEAKER DEVICE AND ELECTRONIC APPARATUS

(71) Applicants: Daisuke SUGII, (US); Yuichiro KISHINAMI, (US); Yasuharu ONISHI, Kawasaki-shi, Kanagawa (JP)

(72) Inventors: Daisuke Sugii, Kawasaki (JP); Yuichiro Kishinami, Kawasaki (JP); Yasuharu Onishi, Kawasaki (JP)

(73) Assignee: NEC CASIO Mobile Communications, Ltd., Kawasaki-shi, Kanagawa (JP)

(21) Appl. No.: 14/427,166

(22) PCT Filed: Sep. 14, 2012
(86) PCT No.: PCT/JP2012/005905

§ 371 Date: Mar. 10, 2015

(51) Int. Cl. H04R 3/04

(52) U.S. Cl. CPC H04R 3/04

(57) ABSTRACT

A frequency setting unit (120) acquires information representing required sound quality for sound output from parametric speakers (140). The frequency setting unit (120) performs determination about whether or not to make the frequency of a modulation signal mutually different among a plurality of parametric speakers (140) based on information representing the acquired sound quality. The frequency setting unit (120) sets the frequency of the modulation signal in each of a plurality of parametric speakers (140) based on the determination result. The modulation unit (130) generates modulation signals having the frequencies set by the frequency setting unit (120). The modulation signals are input to the plurality of parametric speakers (140).

### TECHNICAL FIELD

The present invention relates to a speaker device and electronic apparatus.

### BACKGROUND ART

As a technique for preventing sound from being listened to by other people, a parametric speaker using an ultrasonic wave as a carrier wave has been developed. Since the ultrasonic wave has high directivity, if the parametric speaker is used, a sound field can be formed only in a specific direction, such as the vicinity of a user.

For example, Patent Document 1 discloses that an ultrasonic vibrator array including a plurality of ultrasonic vibrators is used as a parametric speaker and the ultrasonic vibrators are separately controlled to control directivity of sound. Patent Document 1 also describes that the frequency of the carrier wave is changed according to the distance to a region where audible sound should be reproduced.

### RELATED DOCUMENT

### Patent Document

[Patent Document 1] Japanese Unexamined Patent Publication No. 2008-113190

### DISCLOSURE OF THE INVENTION

In the parametric speaker, when the frequency of the carrier wave becomes higher, a frequency with the highest sound pressure in the reproduced audible sound becomes higher. For this reason, if a plurality of frequencies are used as the frequency of the carrier wave, it is possible to increase quality of audible sound. When a carrier wave having a plurality of frequencies is used, since the average frequency of the carrier wave becomes higher, there is a problem in that power consumption of the speaker increases.

An object of the invention is to provide a speaker device and electronic apparatus capable of increasing quality of audible sound as necessary and suppressing an increase in power consumption.

The invention provides a speaker device including a plurality of parametric speakers to which a modulation signal obtained by modulating a sound signal to an ultrasonic band is input, a frequency setting unit which performs determination about whether or not to make the frequency of the modulation signal different among the plurality of parametric speakers based on required sound quality for a sound signal and setting the frequency of the modulation signal in each of the plurality of parametric speakers based on the determination result, and a modulation unit which generates the modulation signals having the set frequencies, in which, when the sound quality is high, the frequency setting unit makes the frequency of the modulation signal different among the plurality of parametric speakers, and when the sound quality is low, the frequency setting unit makes the frequency of the modulation signal consistent among the plurality of parametric speakers and lower than the highest frequency among the frequencies when the sound quality is high.

The invention provides electronic apparatus including the above-described speaker device.

According to the invention, it is possible to increase quality of audible sound as necessary and to suppress an increase in power consumption.

### BRIEF DESCRIPTION OF THE DRAWINGS

The above and other objects, features, and advantages will become more apparent from the following description of preferred embodiments and the accompanying drawings.

FIG. 1 is a diagram showing the functional configuration of a speaker device according to a first embodiment.

FIG. 2 is a diagram showing how the sound pressure of the frequency of sound to be demodulated is changed according to the frequency of a modulation signal.

FIG. 3 is a diagram illustrating the effects of the embodiment.

FIG. 4 is a block diagram showing the configuration of a speaker device according to a second embodiment.

FIG. 5 is a diagram showing a first example of the configuration of a number-of-people detection unit.

FIG. 6 is a diagram showing a second example of the configuration of the number-of-people detection unit.

### DESCRIPTION OF EMBODIMENTS

Hereinafter, embodiments of the invention will be described referring to the drawings. In all drawings, the same constituent elements are represented by the same reference numerals, and description thereof will not be repeated.

### First Embodiment

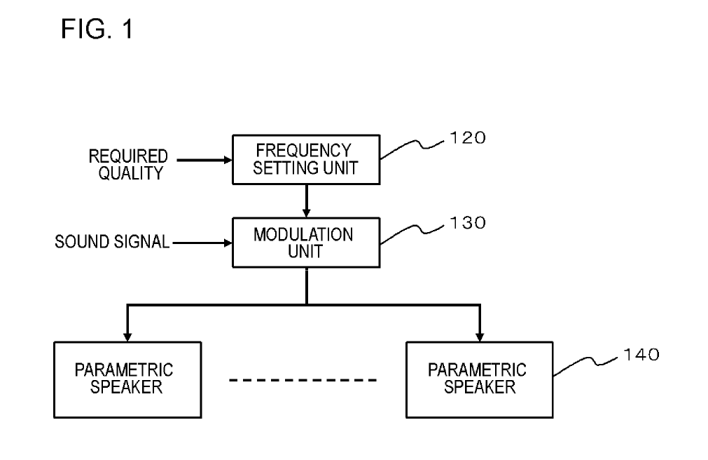

FIG. 1 is a diagram showing the functional configuration of a speaker device according to a first embodiment. The speaker device has a frequency setting unit 120, a modulation unit 130, and a plurality of parametric speakers 140. Each of the plurality of parametric speakers 140 receives a modulation signal obtained by modulating a sound signal in an audible range to an ultrasonic band as input. The frequency setting unit 120 acquires information representing required sound quality for sound output from the plurality of parametric speakers 140. The frequency setting unit 120 performs determination about whether or not to make the frequency of the modulation signal mutually different among the plurality of parametric speakers 140 based on the acquired information representing sound quality. The frequency setting unit 120 sets the frequency of the modulation signal in each of the plurality of parametric speakers 140 based on the determination result. The modulation unit 130 generates modulation signals having the frequencies set by the frequency setting unit 120. The modulation signals are input to the plurality of respective parametric speakers 140.

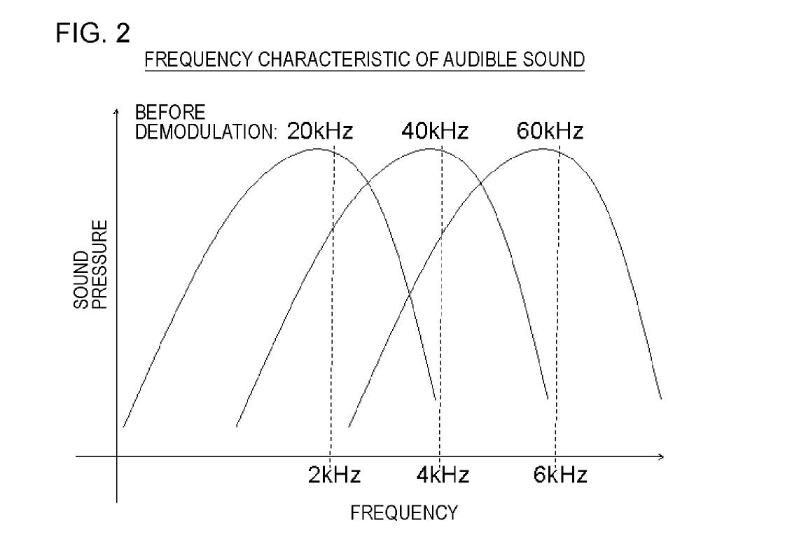

FIG. 2 shows how the sound pressure of the frequency of sound to be demodulated is changed according to the frequency of the modulation signal. As shown in the drawing, when the frequency of the modulation signal becomes higher, a frequency having the maximum sound pressure of sound to be demodulated becomes higher.

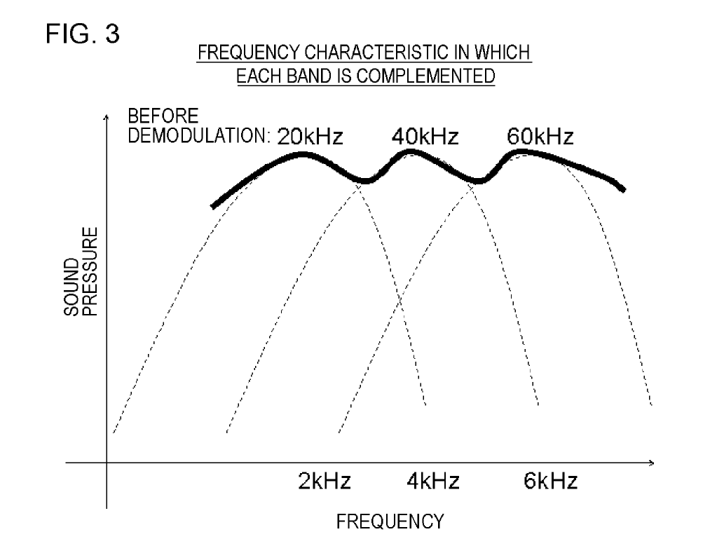

For this reason, as shown in FIG. 3, if the frequency of the modulation signal is made mutually different among the plurality of parametric speakers 140, the frequency dependence of the sound pressure of sound to be demodulated is lowered. Accordingly, quality of demodulated sound increases.

The speaker device is embedded in electronic apparatus, for example, a mobile electronic apparatus, such as a mobile communication terminal. For this reason, as the plurality of parametric speakers 140, parametric speakers having low power consumption are required. If the frequency of the modulation signal becomes higher, the impedance of the plurality of parametric speakers 140 decreases, and power consumption of the plurality of parametric speakers 140 increases.

In contrast, in this embodiment, the frequency setting unit 120 makes the frequency of the modulation signal mutually different among the plurality of parametric speakers 140 when the required sound quality is high. The frequency setting unit 120 makes the frequency of the modulation signal consistent among the plurality of parametric speakers when the required sound quality is low. In this case, the frequency setting unit 120 sets the frequency to be lower than the highest frequency among the frequencies used when the sound quality is high.

Accordingly, it is possible to reduce the amount of power consumption of the plurality of parametric speakers 140.

The frequency setting unit 120 may set the frequency of the modulation signal used when the required sound quality is low to be lower than the average frequency used when the sound quality is high.

Each of the plurality of parametric speakers 140 has a vibration unit which outputs a sound wave, for example, ultrasonic vibrators, such as piezoelectric vibrators. The plurality of parametric speakers 140 are arranged, for example, in an array. The frequency setting unit 120 stores the fundamental resonance frequency of the ultrasonic vibrator in advance and selects a frequency of an integer multiple of the fundamental resonance frequency. For example, when the required sound quality is low, the frequency setting unit 120 sets the fundamental resonance frequency as the frequency of the modulation signal. When the required sound quality is high, the frequency setting unit 120 sets the fundamental resonance frequency and a frequency of N times (where N is equal to or greater than 2 and an integer) the fundamental resonance frequency as the frequency of the modulation signal of each of the plurality of parametric speakers 140. The frequency setting unit 120 sets N in an ascending order.

The modulation unit 130 modulates a sound signal, which should be reproduced by the plurality of parametric speakers 140, to a modulation signal for a parametric speaker. At this time, the frequency of the carrier wave of the modulation signal is set to the frequency set by the frequency setting unit 120.

The frequency setting unit 120 may receive the required sound quality for the sound signal directly from the user as input and may determine the sound quality based on attribute information of the sound signal to be reproduced. The attribute information refers to, for example, a genre (music, sound of movie, conference, or the like) to which the sound signal belongs.

According to this embodiment, it is possible to increase quality of sound output from the plurality of parametric speaker 140 as necessary. It is possible to suppress an increase in power consumption of the plurality of parametric speakers 140.

### Second Embodiment

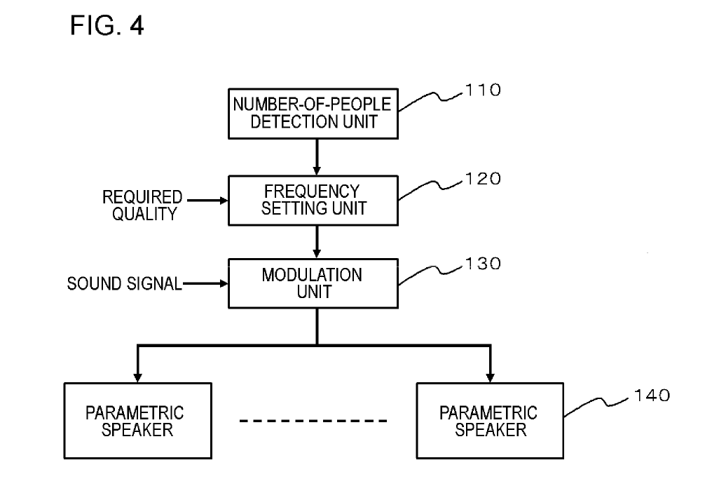

FIG. 4 is a block diagram showing a speaker device according to a second embodiment. The speaker device has the same configuration as the speaker device according to the first embodiment except that a number-of-people detection unit 110 is provided.

It is desirable that directivity of sound output from the plurality of parametric speaker 140 is changed according to the number of people around the electronic apparatus. For example, when there is only the user of electronic apparatus around the electronic apparatus, directivity may not be so high. However, when there are people other than the user around the electronic apparatus, it is necessary to increase directivity to prevent sound from being listened to by people other than the user.

In this embodiment, the number-of-people detection unit 110 detects the number of people around electronic apparatus having the speaker device. The frequency setting unit 120 sets the frequency of the modulation signal when the required sound quality is low based on the number of people detected by the number-of-people detection unit 110. Specifically, when the number of people detected by the number-of-people detection unit 110 is a plural number, the frequency setting unit 120 sets the frequency to be higher than when the detected number of people is one. This is because, as described above, the directivity of sound output from the plurality of parametric speakers 140 increases when the frequency of the modulation signal becomes higher. The directivity of sound output from the plurality of parametric speakers 140 increases when the frequency of the modulation signal becomes higher. Therefore, according to this embodiment, it is possible to meet the above-described needs.

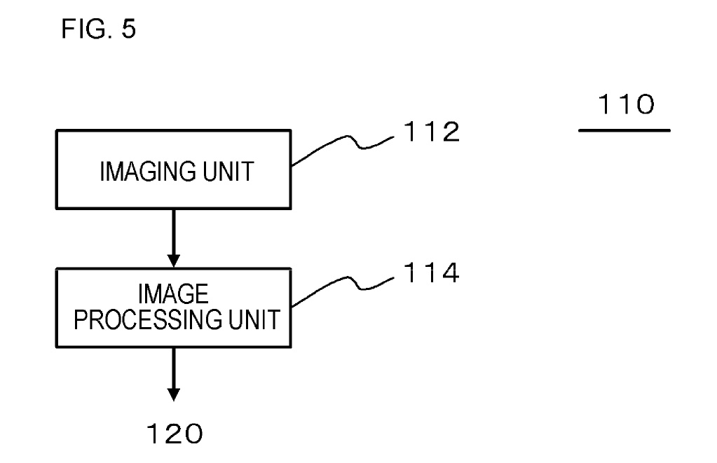

FIG. 5 is a diagram showing a first example of the configuration of the number-of-people detection unit 110. In this example, the number-of-people detection unit 110 has an imaging unit 112 and an image processing unit 114. The imaging unit 112 is, for example, a camera attached to electronic apparatus, and images around the electronic apparatus to generate image data. The image processing unit 114 processes image data generated by the imaging unit 112 to detect the number of people around the electronic apparatus.

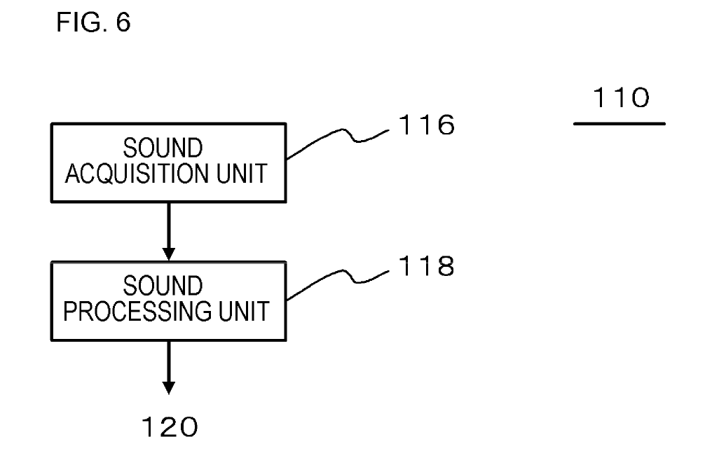

FIG. 6 is a diagram showing a second example of the configuration of the number-of-people detection unit 110. In this example, the number-of-people detection unit 110 has a sound acquisition unit 116 and a sound processing unit 118. The sound acquisition unit 116 is, for example, a microphone attached to electronic apparatus, and converts sound around the electronic apparatus to sound data. The sound processing unit 118 processes sound data generated by the sound acquisition unit 116 and recognizes the number of sound sources determined to be a human, thereby detecting the number of people around the electronic apparatus. Since the plurality of parametric speakers 140 are used, a region where audible sound is demodulated can be separated from the microphone. In this case, since an acoustic echo hardly occurs, an acoustic echo canceller is not required.

It is preferable that the number-of-people detection unit 110 has two microphones separated from each other. Thus, the number-of-people detection unit 110 may specify a sound source using a blind source separation (BSS) technique and may recognize the sound source as a person to whom sound should be output. With this, it is possible to detect the position of the user of the electronic apparatus embedded with the speaker device in real time without using apparatus, such as a headset.

The number-of-people detection unit 110 may use the method shown in FIG. 5 and the method shown in FIG. 6 in combination.

In this embodiment, the same effects as in the first embodiment can be obtained. The frequency setting unit 120 sets the frequency of the modulation signal based on the number of people detected by the number-of-people detection unit 110. For this reason, when the required sound quality is low and when there is only the user of electronic apparatus around the electronic apparatus, directivity can be decreased, and when there are people other than the user around the electronic apparatus, directivity can be increased.

Although the embodiments of the invention have been described referring to the drawings, the embodiments are just the illustration of the invention, and various configurations other than the above-described configurations may be used.

What is claimed is:

1. A speaker device comprising:
a plurality of parametric speakers to which a modulation signal obtained by modulating a sound signal to an ultrasonic band is input;
a frequency setting unit which performs determination about whether or not to make the frequency of the modulation signal mutually different among the plurality of parametric speakers based on required sound quality for a sound signal and setting the frequency of the modulation signal in each of the plurality of parametric speakers based on the determination result; and
a modulation unit which generates the modulation signals having the set frequencies,
wherein, when the sound quality is high, the frequency setting unit makes the frequency of the modulation signal mutually different among the plurality of parametric speakers, and
when the sound quality is low, the frequency setting unit makes the frequency of the modulation signal consistent among the plurality of parametric speakers and lower than the highest frequency among the frequencies used when the sound quality is high.

2. The speaker device according to claim 1,
wherein each of the plurality of parametric speakers has a vibration unit which outputs a sound wave, and
the frequency setting unit selects a frequency of an integer multiple of the resonance frequency of the vibration unit as at least one of the frequencies, and when the sound quality is low, sets the fundamental resonance frequency of the vibration unit as the frequency of the modulation signal.

3. The speaker device according to claim 1,
wherein each of the plurality of parametric speakers has a vibration unit which outputs a sound wave,
the speaker device further comprises:
a number-of-people detection unit which detects the number of people around the speaker device, and
the frequency setting unit selects a frequency of an integer multiple of the resonance frequency of the vibration unit as the frequency, and when the sound quality is low, sets the frequency of the modulation signal based on the number of people detected by the number-of-people detection unit.

4. The speaker device according to claim 3,
wherein, when the number of people is a plural number, the frequency setting unit sets the frequency to be higher than when the number of people is one.

5. The speaker device according to claim 3,
wherein the number-of-people detection unit has an imaging unit, and an image processing unit which analyzes an image generated by the imaging unit to detect the number of people.

6. The speaker device according to claim 3,
wherein the number-of-people detection unit has a sound detection unit, and a sound processing unit which analyzes sound data generated by the sound detection unit to detect the number of people.

7. The speaker device according to claim 1,
wherein the frequency setting unit determines the sound quality based on the attribute of the sound signal.

8. Electronic apparatus comprising a speaker device including:
a plurality of parametric speakers to which a modulation signal obtained by modulating a sound signal to an ultrasonic band is input;
a frequency setting unit which performs determination about whether or not to make the frequency of the modulation signal mutually different among the plurality of parametric speakers based on required sound quality for a sound signal and setting the frequency of the modulation signal in each of the plurality of parametric speakers based on the determination result; and
a modulation unit which generates the modulation signals having the set frequencies,
wherein, when the sound quality is high, the frequency setting unit makes the frequency of the modulation signal mutually different among the plurality of parametric speakers, and
when the sound quality is low, the frequency setting unit makes the frequency of the modulation signal consistent among the plurality of parametric speakers and lower than the highest frequency among the frequencies used when the sound quality is high
